(19) United States
(12) Patent Application Publication
(10) Pub. No.: US 2004/0250672 A1
(43) Pub. Date: Dec. 16, 2004

(54) Combination metronome and tempo monitor

(76) Inventor: Phillip Moodie, Mt. Pleasant, SC (US)

Correspondence Address: Frank V. Gallucci, JAECKLE FLEISCHMANN & MUGEL, LLP, Suite 200, 39 State Street, Rochester, NY, 14610-1310, US

(21) Appl. No.: 10/778,558

(22) Filed: Feb. 13, 2004

Related U.S. Application Data
(60) Provisional application No. 60/447,557, filed on Feb. 14, 2003.

(51) Int. Cl. G10H 7/00

(52) U.S. Cl. 84/636

(57) ABSTRACT

The present invention comprises a self-contained, compact and portable device capable of being programmed to operate as either a metronome or a tempo monitor. The compact device further comprises a micro-controller that receives operator commands via dual programming buttons. These commands include; switching between metronome and tempo monitor mode, setting metronome output between 10 to 254 bpm (beats per minute), storing musical keys, and toggling between audible and silent mode. A three digit display provides a numerical representation of the cycle in beats per minute. Furthermore, the device is equipped with an output jack for remote monitoring, and an input jack for attaching an external transducer.

### CROSS-REFERENCE TO RELATED APPLICATION

This application claims the benefit of U.S. Provisional Patent Application, Ser. No. 60/447,557, filed on Feb. 14, 2003.

### FIELD OF THE INVENTION

The apparatus of the present invention relates to a device for teaching and monitoring tempo. More particularly the present invention relates to an electronic device for teaching and monitoring tempo that is programmable and provides a display.

### BACKGROUND OF THE INVENTION

Metronomes, used to indicate the exact tempo in which a work is to be performed, are well known. Attempts to apply a pendulum to a metronome date back to about 1696, however, Johann Nepenuk Maelzel is credited with building upon the work of his predecessors, and manufacturing the first modern metronome in 1816. In 1938, the Franz electronic metronome utilized AC electricity and a synchronous motor to drive an adjustable tempo beating hammer. In the subsequent years, smaller and more versatile electronic metronomes have been developed.

An example of an electronic metronome is described in U.S. Pat. No. 5,850,048 to Ruf entitled “Digital Read-Out Electronic Metronome.” Ruf discloses an electronic metronome that utilizes a keyboard for entry of a data. Other features of the device include a memory means for storing information, a timing means, and a means for converting the signal generated by the timing means into a visual representation of a musical signature suitable for viewing on the display.

Additionally, tempo measurement devices for monitoring the tempo of music played with an instrument generating tempo beats are also known. These devices provide a visual indication of the measured beats per time unit, between two successive beats. Such a device is described in U.S. Pat. No. 5,036,742 to the present inventor entitled “Tempo Monitoring Device and Associated Method.” The device includes a transducer for sensing the beats, an electronic timer for measuring the time interval between two successive beats, and a display associated with the timer for visually displaying the measured time interval in beats per minute.

Musicians often utilize a metronome to indicate a desired tempo, and then refer to a tempo monitor to demonstrate how closely they are to performing to the desired tempo. Because of the complexities of performing with an instrument, it is vital that accompanying tools be simple and few. Simplicity in operation assures less effort expended on peripheral equipment, thereby allowing the musician to place greater emphasis on his performance.

Therefore, what is needed in the art is a single apparatus that can operate as either a metronome or a tempo monitor.

Furthermore, what is needed in the art is such a combination metronome/tempo monitor that allows the musician to quickly, and effortlessly switch between modes.

Still furthermore, what is needed in the art is a single device that can be used by musicians to measure the tempo of music while it is being played, provide a kick off tempo, and provide a data bank of sequentially preprogrammed tempi.

Moreover, what is needed in the art is a combination metronome and tempo monitor will give an indication of upbeat and down beat.

### SUMMARY OF THE INVENTION

The present invention provides a compact device capable of being programmed to operate as either a metronome or a tempo monitor.

Furthermore, the present invention provides a “tempometer” wherein a single device can be used by musicians to measure the tempo of music while it is being played, provide a kick off tempo, and provide a data bank of sequentially preprogrammed tempi.

The invention comprises, in one form thereof, a micro-controller that receives operator commands via dual programming buttons. These commands include switching between metronome and tempo monitor mode, setting metronome output between 10 to 254 bpm (beats per minute), and toggling between audible and silent mode. When the device is programmed to be in metronome mode, the selected bpm cycle can be represented by either visual display only, or visual display and an audible tone. When the device is in tempo monitor mode, an internal or remote transducer monitors tapping and transmits a signal to the micro-controller. The micro-controller then converts the input from the transducer and drives the display to illustrate the time between consecutive beats in bpm.

The internal transducer of the present invention provides for a completely self-contained device with no external wires or hardware. The device is portable, and can be used in one's hand, a music stand, on a drum, as well as other locations as needed.

Additionally, the present invention provides instantaneous beat-to-beat, real-time feedback wherein musicians are immediately shown how their actions affect the meter and tempo. This particular feature is extremely useful for monitoring tempo transitions while segueing between songs. The present invention forces correct metering with negative feedback of inconsistent numbers, thereby reinforces a musician's “internal clock” with positive feedback of consistent numbers, and building confidence in one's ability to meter correctly. Also, the present invention allows for monitoring of foot taps while playing a string, wind, or electronic instrument with one's hands, and additionally allows subtle artistic tempo changes without being in conflict with a click. Jazz drummers may also monitor their tempi by occasionally reverting to a consistent pattern or backbeat.

Furthermore, in addition to being a useful device for DJs, conductors and composers, the present invention is immensely helpful in introducing the somewhat vague concept of meter to new students.

An advantage of the present invention is that it is programmable and compact in design.

A further advantage of the present invention is that the single device can be programmed to operate as either a metronome or a tempo monitor.

A still further advantage of the present invention is the half-cycle digit blink rate, effectively doubling the frequency and thereby rendering what is known in the art as marking the upbeat and the downbeat. This special feature provides a visual tempo doubler, and is very helpful for kickoffs at extreme largo to grave tempi below 40 bpm

An even further advantage of the present invention is that the single apparatus eliminates the need for purchasing the metronome and tempo monitor separately, thereby reducing the associated expense.

### BRIEF DESCRIPTION OF THE DRAWINGS

The invention as well as its features and advantages will become more apparent from the following description of a preferred embodiment of the invention and the accompanying drawings in which like numerals represent like parts.

FIG. 1 is a plan view of the combination metronome/tempo monitor of the present invention.

FIG. 2 is a side elevation view of the combination metronome/tempo monitor of the present invention.

FIG. 3 is a front elevation view of the combination metronome/tempo monitor of the present invention.

FIG. 4 is an isometric view of the combination metronome/tempo monitor of the present invention mounted to a drum.

FIG. 4a is a partial isometric view of the combination metronome/tempo monitor of the present invention mounted to a drum.

FIG. 5 is a block diagram of the control circuit of the present invention.

FIG. 6 is a detailed schematic diagram of the control circuit of the present invention.

FIG. 7 is a flowchart of the programming process and corresponding sequence of events for the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION

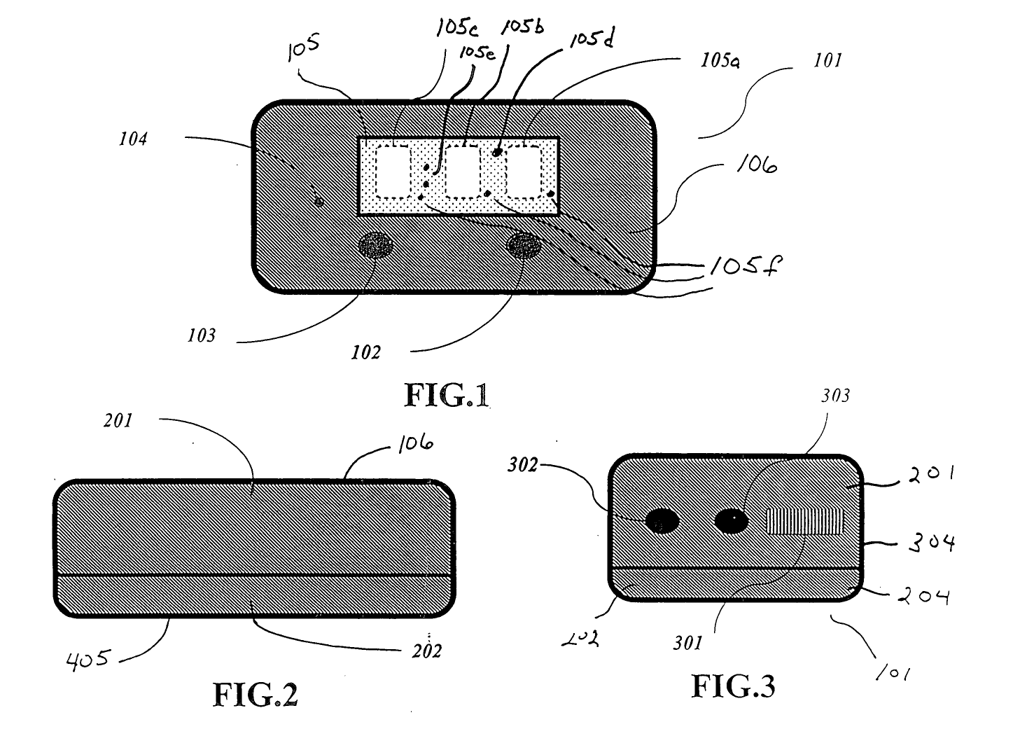

Referring now to the drawings and particularly to FIGS. 1-3, there is shown one embodiment of the combination metronome and tempo monitor 101 of the present invention. The combination metronome and tempo monitor 101 includes a housing means in form of a substantially closed box. The housing means is constructed of a suitable material and is defined by two opposite side surfaces and opposite top and bottom surfaces 106 and 405 respectfully. The top surface 106 of the apparatus 101 as illustrated in FIG. 1 includes a three digit LED display 105, and programming buttons 102 and 103. Generally, the apparatus can be programmed via the program buttons 102 and 103 to operate as either a metronome or a tempo monitor. While in metronome mode, the programming buttons may be used to select a desired tempo, page between sixty-six programmable presets, or switch between audible and mute mode. Additionally, the programming keys are used to program the sixty-six programmable presets. Additionally, the present invention allows for all 12 musical keys, A through G#, to be stored in each preset. In the event the operator does not wish to utilize this feature, a blank value can be stored in any particular preset, thereby bypassing this step and saving time between musical performances.

Referring again to FIG. 1, the top surface 106 of the apparatus 101 has a small opening 104, to allow the operator to hear an audible tone emanating from within the housing of the device 101. This audible tone is only produced while the device is operating in audible mode.

The left side surface 304 of the housing as illustrated in FIG. 3 shows the upper portion 201 and the lower portion 202 of the housing of the device 101. The upper portion 201 of the left side of the housing 304 contains two jacks 302 and 303 and a sensitivity dial 301. The external input/transducer jack 303 may be utilized when the device is in tempo monitor mode. Furthermore, the external input/transducer jack 303 is used for connecting an additional external transducer (not shown) to the device. Each time a beat is detected by the transducer, the three decimals 105(f) will flash. Also, the sensitivity dial 301 can be adjusted to filter out ghost notes picked up by the transducer.

The output/monitoring jack 302 may be used to connect headphones, or any suitable monitoring device to deliver an audible indication of the selected beats per minute cycle to the operator. The output/monitoring jack 302 is active while the device is in metronome mode.

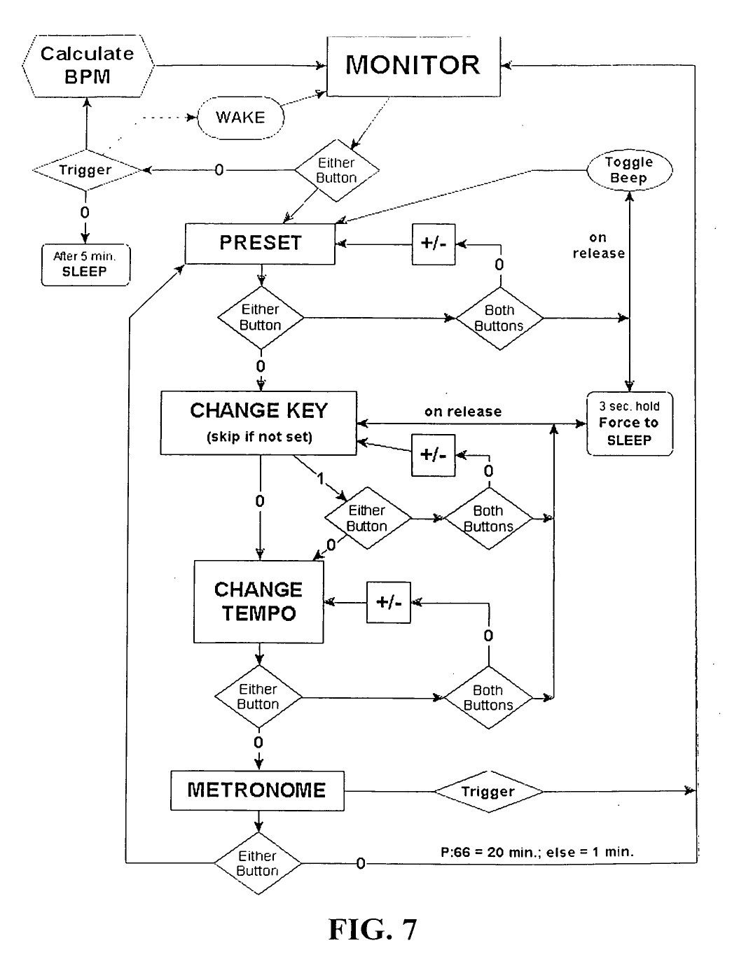

Referring to FIG. 1 and the flow chart of FIG. 7, the device 101 is activated by tapping the casing of the unit. When the device 101 is activated (also referred to as wake mode) a “1” will appear in the three digit LED display 105. In the event that no further action is taken the device will turn off in 30 seconds. The purpose of this feature is to conserve battery power should the device 101 be erroneously turned on. It should be further noted that the device can be turned off manually. This is accomplished by depressing buttons 102 and 103 simultaneously for 3 seconds.

After the device is turned on (wake mode), it immediately enters monitor mode. Tapping on the bottom of the device, or an external transducer, will render a beat to beat real time evaluation of the tempo in beats per minute. As stated above this rate will be displayed on the three digit LED display 105, and the three decimals 105(f) will flash. The detectable range in tempo monitor mode is 10 to 255 beats per minute.

As discussed above, the present invention allows for all 12 musical keys, A through G#, to be stored in each preset. As illustrated in FIG. 7, if the operator does not wish to utilize this feature, a blank value will be stored in the preset, thereby bypassing that particular step for that preset.

Metronome mode is selected by pressing either button while in monitor mode. The first step of metronome mode shall be referred to as program mode. Upon entering metronome mode, a “P” will be illustrated in the first digit 105c of the three digit LED display, followed by a colon 105e, and a numeral between one and sixty-six. The “P” indicates to the operator that the device is now in program mode, with the following numeral identifying the individual programmed preset. While the “P” is displayed, the operator can page through the sixty-six programmable presets using the two programming buttons 102 and 103. The left programming button 103 is used to page down, and the right programming button 102 is used to page up. While holding either button, the number steps slowly five times and then increments/decrements faster to arrive more quickly at a distant program. Once the operator has selected the desired program, removing his finger from either button will enable the display to indicate a number between 10 and 254 with an apostrophe 105d appearing between the middle digit 105b and the right digit 105a of the display 105. While the apostrophe 105d is illuminated, the operator can use the left programming button 103 to reduce the number of beats per minute, or the right programming button 102 to increase the number of beats per minute. As in program mode, while holding the button, the number steps slowly five times and then increments/decrements faster to arrive more quickly at a distant tempo. Once the desired tempo is selected, releasing the buttons 102 or 103 will enter, or assign the selected tempo (between 10 and 254 bpm) to the corresponding preset number (between one and sixty-six), and the display 105 will begin to flash at the selected tempo. Switching between audible and mute mode is accomplished by pressing and releasing the left programming button 103 and the right programming button 102 simultaneously. A lower case “b” in the left digit 105c indicates that the device is in audible mode, and a “-” in the left digit 105c indicated that the device is in mute mode. The device will go from metronome mode to tempo monitor mode upon the detection of a beat by the transducer, or after one minute has elapsed. Furthermore, one or more of the sixty-six programmable presets can be preprogrammed to operate as a metronome for a period greater than 1 minute. For example, P:66 can be programmed to operate as a metronome for twenty minutes, thereby enhancing the devices capabilities as a practice tool.

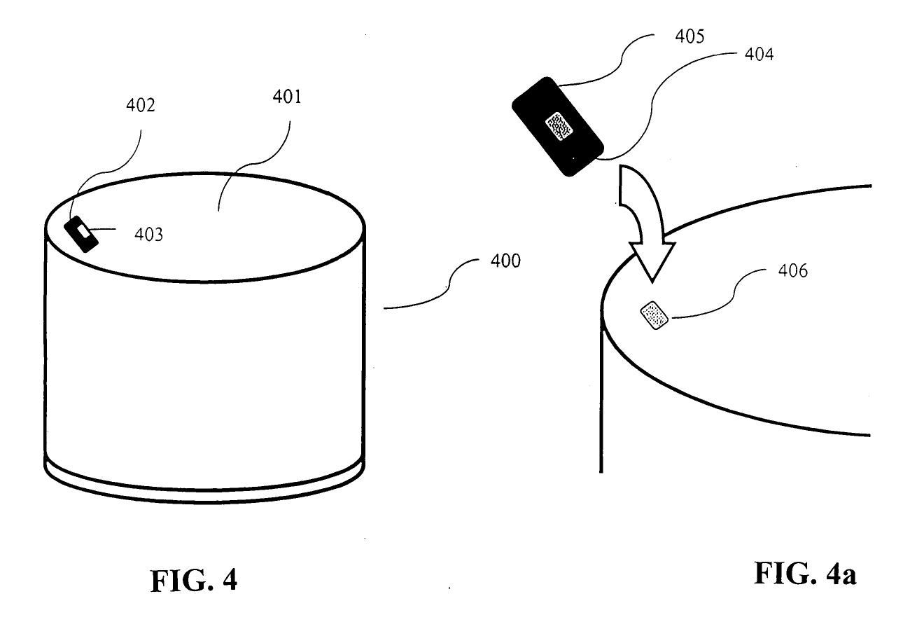

A particular method of mounting the combination metronome/tempo monitor 101 of the present invention to a drum 400 is illustrated in FIGS. 4 and 4a. FIG. 4 illustrates the combination metronome/tempo monitor 101 mounted on the face top/batter head 401 of drum 400. FIG. 4a further illustrates a fastening means, such as the hook and pile pieces of a fastener 404, 406. One part of the fastener 406 is attached to the head 401 of the drum 400, and the other part 404 is attached to the bottom surface 405 of the combination metronome/tempo monitor 101. The fastener removably interlocks the combination metronome/tempo monitor 101 with the face 401 of drum 400 when pressed together. While the illustrated embodiment utilizes Velcro fasteners, any suitable means for fastening the combination metronome/tempo monitor 101 to the face top/batter head 401 of drum 400 is within the scope of the invention.

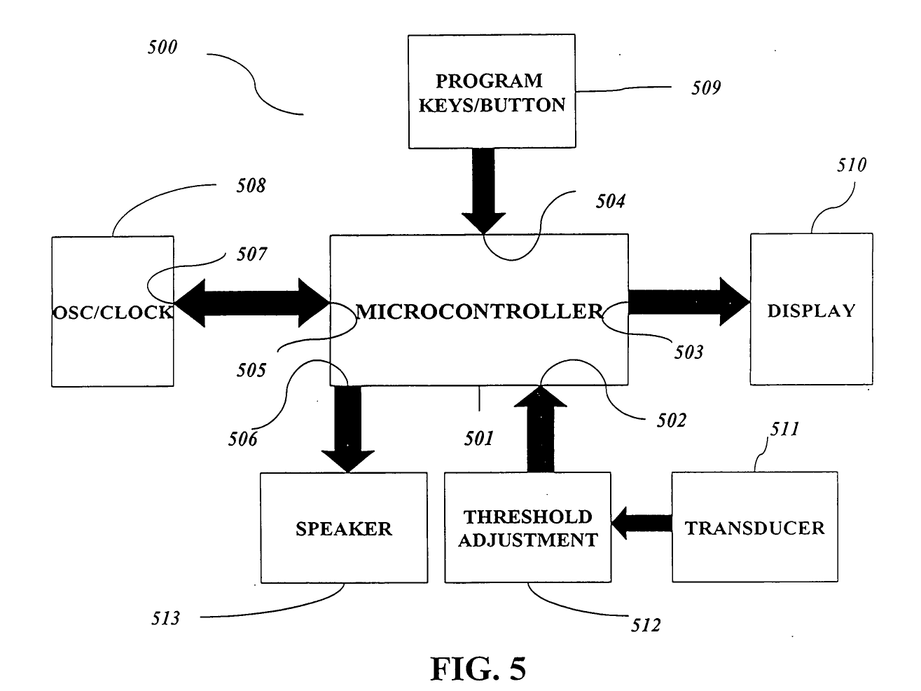

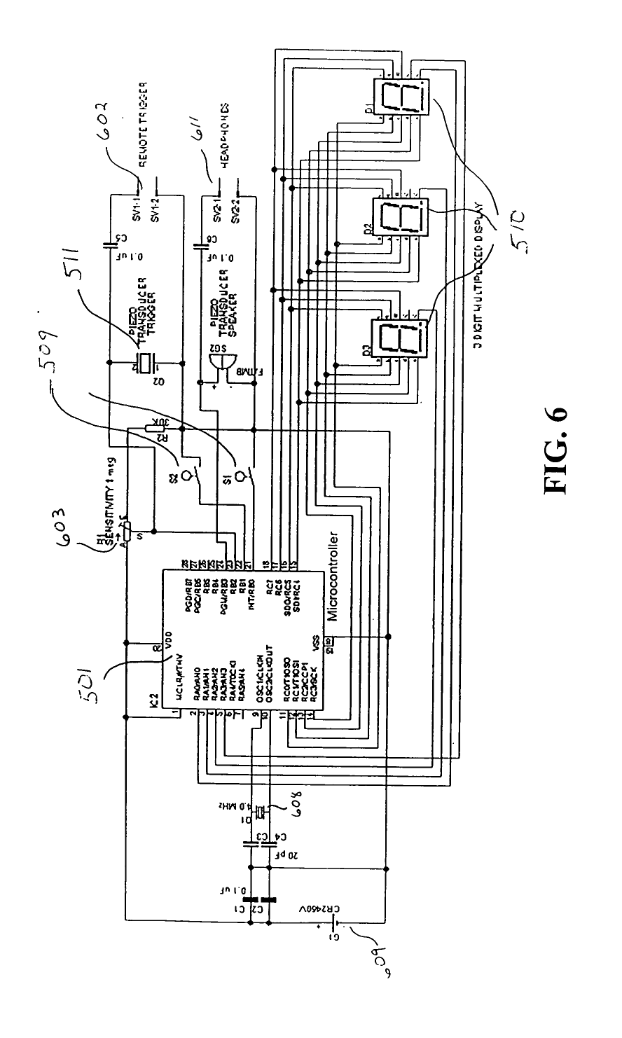

FIG. 5 is a block diagram and FIG. 6 is a detailed schematic diagram of the control circuit of the device of the present invention. In FIG. 6, there is shown a quartz crystal 608 for use for controlling the timing of the device, and a battery 609 for providing power to the device and components. The quartz crystal 608 of a particular embodiment of the invention can be a 4.0 MHz Oscillator. The quartz crystal 608 is also represented in FIG. 5 as the Osc/Clock 508. The microcontroller 501 performs the signal conditioning and timing functions before driving the three digit display 510. The display 510 then provides the operator a numerical real time indication between beats in beats per minute (bpm). The range displayed in this mode is 10 bpm to 255 bpm. When the device is programmed to be in monitor mode, the device is advantageous in that it provides the operator real time visual feedback of the actual tempo being played.

The microcontroller 501 of the present invention performs all of the arithmetic and logic functions. In addition to the internal timers (start up timer, watchdog timer, etc.), essential to the devices operation, an external 4.0 MHZ crystal oscillator, as stated above, along with associated pair of 20 pf capacitors is connected to the clock input to define the instruction cycle. The software governing the microcontroller was written with timing based on the 4.0 MHz crystal.

The microcontroller also contains internal memory, namely program memory and data memory. As mentioned above, sixty-six programmable presets are available. This is a function of the EPROM or program memory. The data memory is generally partitioned into the general purpose registers and the special function registers. The general purpose register as accessed through the file select register (FSR), receives instructions from the programming buttons 102 and 103.

When the device is programmed to be in tempo monitor mode, a monitoring means 511 such as a piezoelectric transducer is used to sense relatively strong tempo beat vibrations. Furthermore, the microcontroller is responsible for sinking, or enabling the monitoring means 511 or transducer.

In addition to the internally mounted monitoring means 511, the device further includes a receptacle or external input/transducer jack 303 and additional input connection circuitry 602. The input connection circuitry allows for the addition of a second monitoring means also known as a remote trigger (not shown.)

Referring once again to FIG. 4, the device 101 is shown mounted to a drum skin 401, wherein the internally mounted monitoring means or transducer 511 (FIGS. 5 and 6), generates an electrical impulse in response to the tempo beat. It should be further noted that the impulse or signal can be filtered to eliminate false signals. Referring again to FIGS. 5 and 6, a sensitivity control or filtering means 502, such as potentiometer 603, is included to filter out unwanted or ghost notes.

Alternatively, the circuit can be programmed to operate as a metronome. The various modes, such as monitor mode or metronome mode, are selected by programming the microcontroller via program buttons 509. When the device is operating in metronome mode the operator will have access to 66 programmable presets. Alternatively, as previously discussed, a specific bpm can be selected via programming buttons 509. The selectable bpms range from 10 bpm to 254 bpm, and the rate selected appears on the three digit LED display 510. In addition to the three digit LED display 510 showing the selected bpm rate, the digits will cycle on and off at the rate selected.

Additionally an audible signal device is connected to the micro controller to emit an audible signal at the start of a cycle. The audible signal may be in the form of a beep or tone. In the preferred embodiment of the present invention the audible signal is produced by a low impedance direct drive piezo buzzer, driven by the microcontroller. This feature may be disabled or rendered mute via program the buttons 509. Also, additional circuitry 611 is provided to allow for the use of headphones via the output jack.

A further feature of the device of the present invention is the half-cycle digit blink rate. At the start of the cycle the digits of the LED 510 are illuminated, and an accompanying audible signal (if selected). Halfway through the period, the digits of the LED 510 extinguish, effectively doubling the frequency and thereby rendering what is known in the art as marking the upbeat and the downbeat. This feature is important to the operator, particularly at slower tempos.

The three digit LED display 510 is also driven by the microcontroller. In the preferred embodiment of the present invention, a multiplexing scheme is used to drive the display, thereby reducing the number of input/output lines needed. The microcontroller's capability of driving the LEDs eliminates the need for external devices, such as transistors, to perform this function, thereby reducing the overall size as well as the cost of the device.

While this invention has been described as having a preferred design, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

I claim:

1. A programmable metronome and meter monitor comprising:
a program entry means for entering commands to a processing means and switching between metronome and tempo monitor mode;
a sensing means for sensing a beat and converting said beat to a beat signal; and
a display means for communicating the tempo to an operator.

2. The programmable metronome and meter monitor of claim 1, further comprising a means for audibly indicating a programmed tempo.

3. The programmable metronome and meter monitor of claim 1, further comprising an output jack for transmitting an audible indication of a programmed tempo.

4. The apparatus of claim 1, further comprising an input jack for receiving a signal from an external sensing device, thereby providing tempo signals in response to tempo beats.

5. The programmable metronome and meter monitor of claim 1, wherein said processing means turns the programmable metronome and meter monitor off after a period of inactivity.

6. The programmable metronome and meter monitor of claim 1, further comprising a sensitivity control potentiometer for filtering out background noise.

7. A method of mounting the programmable metronome and meter monitor of claim 1 to a musical instrument, comprising the steps of:
attaching a first fastening means to the musical instrument;
attaching a second fastening means to a lower surface of the combination programmable metronome and tempo monitoring device; and
attaching the first fastening means to the second fastening means.

8. The programmable metronome and meter monitor of claim 1, wherein said display means further comprises a series of digits that extinguish halfway through the period and re-illuminate at the beginning of the next period, thereby representing an upbeat and a downbeat of a tempo cycle.

9. The programmable metronome and meter monitor of claim 1, further comprising a plurality programmable presets for storing and selecting a desired tempo.

10. The programmable metronome and meter monitor of claim 9, wherein all twelve musical keys may be stored in each of said plurality programmable presets.

11. A programmable metronome and meter monitor comprising:
a housing assembly comprising an upper portion and a lower portion, said housing assembly adapted for manual operation or upon a musical instrument;
a sensing means adapted to fit internally within said lower portion of said housing assembly for providing tempo signals in response to tempo beats;
a pair of programming buttons mounted on said upper portion of said housing assembly for receiving input commands from an operator;
a microprocessor means within said housing assembly, adapted to receive signals from said programming buttons and allow for switching between a meter monitor mode and a metronome mode;
said microprocessor means adapted to receive said tempo signals from said sensing means during monitor mode, measure time interval between successive beats, and calculate the number of beats per unit of time;
said microprocessor means adapted to receive a metronome programming signal during said metronome mode for selecting a metronome output;
a display means mounted on said upper portion of said housing assembly and associated with said microprocessor means for providing a visual indication of calculated value of number of beats per minute during the meter monitoring mode, and an visual representation of the programmably selected beats per minute as entered through the programming buttons.

12. The programmable metronome and meter monitor of claim 11, further comprising a means for audibly indicating a programmed tempo.

13. The programmable metronome and meter monitor of claim 11, further comprising an output jack for transmitting an audible indication of a programmed tempo.

14. The programmable metronome and meter monitor of claim 11, further comprising an input jack for receiving a signal from an external sensing device, thereby providing tempo beat signals in response to tempo beats.

15. The programmable metronome and meter monitor of claim 11, wherein said microprocessor means turns the programmable metronome and meter monitor off after period of inactivity.

16. The programmable metronome and meter monitor of claim 11, further comprising a sensitivity control potentiometer for filtering out background noise.

17. A method of mounting the programmable metronome and meter monitor of claim 11 to a musical instrument, comprising the steps of:
attaching a first fastening means to the musical instrument;
attaching a second fastening means to lower surface of the housing assembly; and
attaching the first fastening means to the second fastening means.

18. The apparatus of claim 11 wherein said digits of said display extinguish halfway through the period and re-illuminate at the beginning of the next period, thereby representing an upbeat and a downbeat of a tempo cycle.

19. The programmable metronome and meter monitor of claim 11, further comprising a plurality programmable presets for storing and selecting a desired tempo.

20. The programmable metronome and meter monitor of claim 19, wherein all twelve musical keys may be stored in each of said plurality programmable presets.
